(19) United States
(12) Patent Application Publication
(10) Pub. No.: US 2006/0198527 A1
(43) Pub. Date: Sep. 7, 2006

(54) Method and apparatus to generate stereo sound for two-channel headphones

(76) Inventor: Ingyu Chun, Yongin-si (KR)

Correspondence Address: STANZIONE & KIM, LLP, 919 18TH STREET, N.W., SUITE 440, WASHINGTON, DC, 20006, US

(21) Appl. No.: 11/359,443

(22) Filed: Feb. 23, 2006

(30) Foreign Application Priority Data
Mar. 3, 2005 (KR) 2005-17667

(51) Int. Cl. H04R 5/00; H04R 5/02

(52) U.S. Cl. 381/17; 381/309

(57) ABSTRACT

A method and apparatus to generate a stereo sound for two-channel headphones from a multi-channel audio signal reproduced from a recording medium. The method may include generating a direct sound and reflected sounds by delaying one of a plurality of channel signals using a plurality of different delay coefficients, multiplying the generated sounds by predetermined different gain values, dividing the multiplied sounds into left and right channel sounds by reflecting a time difference between two ears of a listener on each of the multiplied sounds, low-pass-filtering the left and right channel sounds by reflecting a level difference between the two ears of the listener on each of the left and right channel sounds, and adding together the low-pass-filtered left channel sounds and the low-pass-filtered right channel sounds, respectively.

### CROSS-REFERENCE TO RELATED APPLICATIONS

This application claims the benefit of Korean Patent Application No. 2005-17667, filed on Mar. 3, 2005, in the Korean Intellectual Property Office, the disclosure of which is incorporated herein in its entirety by reference.

### BACKGROUND OF THE INVENTION

1. Field of the Invention

The present general inventive concept relates to a stereo sound generation system, and more particularly, to a method and apparatus to generate a stereo sound for two-channel headphones from a multi-channel audio signal reproduced from a recording medium, such as a DVD.

2. Description of the Related Art

Recently, techniques which allow a listener to listen to three-dimensional sounds using headphones without 5.1 channel speakers have been realized.

A home theater system outputs sounds using 5 speakers. However, all of the sounds do not directly reach the ears of the listener. Some of the sounds reach the ears of the listener after being reflected from walls or furniture in a room. When sound signals reach the ears of the listener, the brain of the listener receives all of the sound signals and senses them as stereo sounds.

To realize a stereo sound using only general headphones, a stereo sound generating system based on a processor coding audio information has been developed.

A technology relating to a conventional stereo sound reproducing system is disclosed in WO 99/49574 (PCT/AU99/00002, filed 6 Jan. 1999, entitled AUDIO SIGNAL PROCESSING METHOD AND APPARATUS).

In the technology relating to the conventional stereo sound reproducing system, a multi-channel audio signal is downmixed into a 2-channel audio signal using a head-related transfer function (HRTF).

FIG. 1 is a block diagram illustrating a conventional stereo sound reproducing system.

Referring to FIG. 1, a 5.1 channel audio signal is input to a conventional stereo sound reproducing system 1. The 5.1 channel audio signal includes a left-front channel, a right-front channel, a center-front channel, a left-surround channel, a right-surround channel, and a low-frequency channel 13. Left and right impulse response functions are applied to each of the channels. A left-front impulse response function 4 for the left ear is convoluted with a left-front signal 3 output from the left-front channel 2. This convolution operation is denoted by reference numeral 6. The left-front impulse response function 4, which is an ideal spike output from a left-front channel speaker located at an ideal position, uses a HRTF as an impulse response to be received by the left ear. An output signal 7 is mixed for a left channel signal 10 for headphones. Similarly, a left-front impulse response function 5 for the right ear is convoluted with the left-front signal 3 from the left-front channel 2. This convolution operation is denoted by the reference numeral 8. Anoutput signal 9 is mixed for a right channel signal 11 for headphones. Therefore, the system 1 of FIG. 1 requires 12 convolution operations for the 5.1 channel audio signal. Accordingly, even if the 5.1 channel audio signal is reproduced as a 2-channel audio signal by being downmixed using a combination of the measured HRTFs, the same surround effect as when the 5.1 channel audio signal is reproduced as a multi-channel audio signal can be obtained.

However, the non-individualized HRTF (e.g., the left-front impulse response function 4) applied to the system illustrated in FIG. 1 has a frequency response difference in a high frequency band from an individualized HRTF. That is, an HRTF in a free space can be defined as a transfer function from a sound source to a human eardrum. A frequency component of a sound signal in one ear represented by a HRTF and an interaural level difference (ILD) are very sensitive to an ear shape of the listener in a high frequency band of more than about 5 KHz since the human ears have unique shapes and various frequency characteristics causing resonances.

A HRTF represents several peaks and dips, especially in a high frequency band. Since the peaks and dips are mainly formed due to the resonance in the human ear, locations of the peaks and dips are different between different people due to their different ear shapes. Accordingly, the HRTF is different between different people.

As described above, the conventional stereo sound reproducing system illustrated in FIG. 1 has problems of distortion of timbre and incorrect localization of sound due to a difference between the non-individualized HRTF and the individualized HRTF. In addition, the conventional stereo sound reproducing system illustrated in FIG. 1 has a problem of an increase in the amount of calculation due to the execution of the convolution between each signal and the non-individualized HRTF.

### SUMMARY OF THE INVENTION

The present general inventive concept provides a method and apparatus to generate a stereo sound for two-channel headphones by reflecting a stereophonic effect and a virtual room effect on each channel signal.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of generating a stereo sound for two-channel headphones from a plurality of channel signals, the method including generating a direct sound and reflected sounds by delaying one of the plurality of channel signals using a plurality of different delay coefficients corresponding to the direct and reflected sounds, multiplying the delayed sounds by predetermined different gain values corresponding to the delayed sounds, dividing the multiplied sounds into left and right channel sounds by reflecting a time difference between two ears of a listener on each of the multiplied sounds, low-pass-filtering the divided left and right channel sounds by reflecting a level difference between the two ears on each of the left and right channel sounds, and adding together the low-pass-filtered left channel sounds and the low-pass-filtered sounds of the right channel sounds, respectively.

The method may further include generating a low-frequency channel signal, generating a compensation signal to compensate for differences in intensities and delay times between the low-frequency channel signal and signals of the plurality of channels, and adding the compensation signal to the left and right channel sounds. The method may not include using a head-related transfer function.

The foregoing and/or other aspects and utilities of the present general inventive concept may also be achieved by providing a headphone stereo sound generating apparatus including a stereo sound filter unit to output left and right channel sounds by reflecting a sound pressure difference between two ears of a listener, a delay time in a virtual room, and an intensity of a sound source on each channel signal, and an adder unit to add together the left channel sounds output from the stereo sound filter unit and the right channel sounds output from the stereo sound filter unit, respectively.

The foregoing and/or other aspects and utilities of the present general inventive concept may also be achieved by providing a method of generating stereo sound for two-channel headphones, including calculating an interaural time difference for each of a direct sound and a plurality of reflected sounds, and calculating an interaural level difference for each of the direct sound and the plurality of reflected sounds. The method may further include assigning different delay coefficients to each of the direct sound and the reflected sounds corresponding to the interaural time difference of each of the direct sound and the reflected sounds, and assigning different gain values to each of the direct sound and the reflected sounds corresponding to the interaural level difference of each of the direct sound and the reflected sounds.

The foregoing and/or other aspects and utilities of the present general inventive concept may also be achieved by providing a stereo sound generating apparatus, including a generation unit to generate a direct sound and reflected sounds by delaying one of the plurality of channel signals using a plurality of different delay coefficients corresponding to the direct and reflected sounds, a multiplier unit to multiply the generated sounds by predetermined different gain values corresponding to the generated sounds, a divider unit to divide the multiplied sounds into left and right channel sounds by reflecting a time difference between two ears of a listener on each of the multiplied sounds, a filter unit to low-pass-filter the divided left and right channel sounds by reflecting a level difference between the two ears on each of the left and right channel sounds, and an adder unit to add together the low-pass-filtered left and right channel sounds, respectively.

The foregoing and/or other aspects and utilities of the present general inventive concept may also be achieved by providing a stereo sound generating apparatus, including a stereo sound filter unit to delay at least one signal of a plurality of channel signals using a plurality of different time delay coefficients previously-measured in a virtual room, the stereo sound filter unit including a plurality of virtualizer filters, and a signal compensation filter unit to generate a compensation signal to compensate for differences in intensities and delay times between a signal of a low-frequency channel and the plurality of channel signals. The virtualizer filters may have substantially-similar structures with different time delay coefficients. The apparatus may further include a filter unit to low-pass-filter the plurality of channel signals from the stereo sound filter unit. The apparatus may further include at least one adding unit to add together the plurality of channel signals and the compensation signal. The apparatus may further include at least one amplifier to amplify the added signals from the at least one adding unit and to input the amplified signals into at least one two-channel headphone. The stereo sound filter unit may include a timing unit to calculate an interaural time difference for each of the plurality of channel signals and to assign different ones of the time delay coefficients to the plurality of channel signals based on the interaural time differences.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional stereo sound reproducing system;

FIG. 2 is a conceptual diagram illustrating a method to generate a stereo sound for two-channel headphones according to an embodiment of the present general inventive concept;

FIG. 3 is a conceptual diagram illustrating a generation of a reflected sound in a virtual room;

FIG. 4 is a conceptual diagram illustrating a time difference of sound traveling to two ears of a listener;

FIG. 5 is a block diagram illustrating a headphone stereo sound generating apparatus according to an embodiment of the present general inventive concept; and

FIG. 6 is a detailed diagram illustrating a virtual filter for a stereo sound filter unit illustrated in FIG. 5.

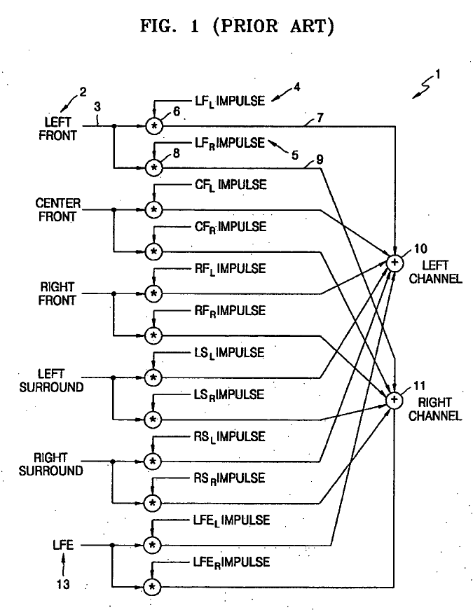

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

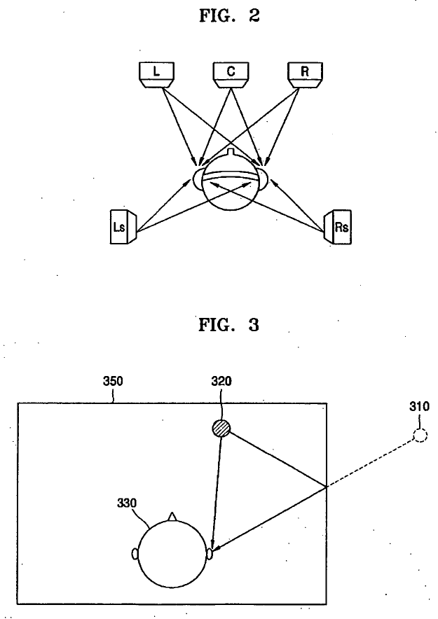

FIG. 2 is a conceptual diagram illustrating a method to generate stereo sounds for two-channel headphones according to an embodiment of the present general inventive concept.

Referring to FIG. 2, multi-channel virtual speakers L, C, R, Ls, and Rs are arranged in a virtual room based on locations of standard speakers reproducing multi-channel audio. For example, when 5.1 channel virtual speakers are arranged, left channel signals output from the 5.1 channel virtual speakers are added together for a left set of headphones, and right channel signals output from the 5.1 channel virtual speakers are added together for a right set of the headphones.

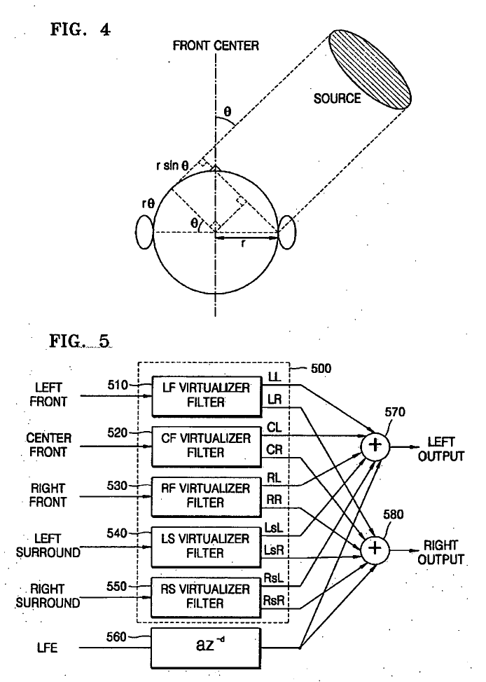

FIG. 3 is a conceptual diagram illustrating the generation of a reflected sound in a virtual room, and FIG. 4 is a conceptual diagram illustrating a time difference of sound traveling to two ears of a listener;

When a virtual speaker is located in a virtual room having a predetermined shape and predetermined boundaries, and a listener is placed at an optimal location, a direct sound is directly transferred from the virtual speaker to the listener, and reflected sounds reflected from virtual walls of the virtual room are also transferred to the listener. The direct sound and the reflected sounds have different delay times, amounts of sound pressure, and angles of incidence on the respective ears of the listener.

When a stereo sound is not reproduced or not correctly reproduced in a headphone stereo sound generating system, a phenomenon in which a sound image is localized in a head, so-called an “in-head localization” phenomenon, easily occurs. By adding the reflected sounds generated in the virtual room to the sounds reproduced in headphones, the “in-head localization” phenomenon can be removed and the sound image can be localized at a desired location outside of the head of the listener (e.g., before sound is passed to the ears of the listener).

The reflected sounds can be generated using a simple structural model of a room. FIG. 3 illustrates mirror image sources of one sound source 320 in a given virtual room 350. A mirror image source 310 is a virtual source obtained by the sound source 320 reflected from a wall which is a plane of symmetry. A delay time of the reflected sound arriving at the ear of a listener 330 from the sound source 320 and reflected from the virtual wall can be replaced with a delay time of a direct sound arriving at the ear of the listener 330 directly from the sound source 320. An intensity of the reflected sound can be calculated based on an intensity of the mirror image source 310 depending on acoustic absorptivity of the wall. Originally, virtual sources in addition to the sound source 320 are regenerated as an infinite number of sound sources due to the sounds reflected by walls of the virtual room 350. An appropriate finite number of virtual sources are selected from among the infinite number of virtual sources. The delay time and the intensity of each of the selected virtual sources are calculated. An interaural time difference (ITD) and an interaural level difference (ILD) of each of the selected virtual sources according to the angle of incidence of each of the selected virtual sources with respect to the listener 330 are calculated. The calculated ITD and ILD parameters vary according to the shape and boundaries of the virtual room and the locations of the listener 330 and the sound source 320. Thus, it is necessary to properly design the virtual room 350 in order to generate effective reflected sounds.

In a method of generating a headphone stereo sound according to an embodiment of the present general inventive concept, delay times of a direct sound and reflected sounds taken to reach a listener from virtual speakers in a virtual room are measured. Delay coefficients m₀ through mₙ corresponding to the delay times depend on the size of the virtual room. Assuming that the number of reflected sounds is n, the delay coefficients m₀ through mₙ of the direct sound and the n reflected sounds are different. Gain values g₀ through gₙ corresponding to the intensities of the sounds are measured for the direct sound and the n reflected sounds. ITD values and ILD values, which allows relative locations of sound sources to be perceived from sound pressure differences between the sound signals incident on the two ears of the listener, are measured. That is, an ITD is a time difference between the sound signals to the two ears of the listener from a sound source as illustrated in FIG. 4 that occurs due to a difference between paths. The ITD can be represented by Equation 1:
ITD=r(θ+sin θ)/C₀ (1)
where r is a distance from the ear closest to the sound source to the middle of the listener's head, and C₀ is a sound velocity of about 344 m/s in air.

The ITD can be effectively perceived in a low frequency band of about 700 Hz or less. With the assumption that there are n sounds, left ITD values itd_{L0}, itd_{L1}, . . . , itd_{Ln} and right ITD values itd_{R0}, itd_{R1}, . . . , itd_{Rn} are different from each other. For example, when the virtual speaker is located on the right of a listener, the itd_{L0} value of the direct sound is greater than the itd_{R0} value, as the distance from the virtual speaker to the left ear of the listener is greater than the distance from the virtual speaker to the right ear of the listener.

An ILD is an amplitude difference, an intensity difference, or a level difference between the sound signals transferred to the two ears of the listener. The ILD mainly occurs due to a sound dispersion effect occurring in the head and ears of the listener. The ILD can be represented by Equation 2:
ILD=20 log₁₀(|HRTF_{R}|/|HRTF_{L}|) (2)

The ILD can be effectively perceived in a high frequency band (e.g., more than about 5 KHz). The ILD depends on the shape of the head or ears of the listener, and thus differs between people. The dispersion effect caused by the listener's head appears as a peak in a spectrum in which the amplitude of a high-pitched tone is trimmed as a result of low-pass-filtering sound pressure in the ear far from the sound source, and the dispersion effect caused by the listener's ears appears as peaks and dips in a high frequency band due to the frequency characteristics in the ears causing resonances, for example, as in a HRTF. Since the ILD between listeners caused by the different shapes of their ears is smaller than the ILD caused by the different shapes of their heads, the ILD obtained only through low-pass-filtering less depends on the listener.

With the assumption that there are n sounds, left ILD values ild_{L0}, ild_{L1}, . . . , ild_{Ln} and right ILD values ild_{R0}, ild_{R1}, . . . , ild_{Rn} are different from each other. For example, when the virtual speaker is located on the right of a listener, a high-pitched tone of the ild_{L0} value of the direct sound is more trimmed than that of the ild_{R0} value, as the distance from the virtual speaker to the left ear of the listener is greater than the distance from the virtual speaker to the right ear of the listener.

FIG. 5 is a block diagram illustrating a headphone stereo sound generating apparatus according to an embodiment of the present general inventive concept.

Referring to FIG. 5, the headphone stereo sound generating apparatus includes a stereo sound filter unit 500, a signal compensation filter unit 560, a left channel adder 570 and a right channel adder 580. The stereo sound filter unit 500 includes a left front (LF) virtual filter 510, a center front (CF) virtual filter 520, a right front (RF) virtual filter 530, a left surround (LS) virtual filter 540 and a right surround (RS) virtual filter 550.

A 5.1 channel audio signal may be input to the headphone stereo sound generating apparatus. The 5.1 channel audio signal may include an LF channel, an RF channel, a CF channel, an LS channel, an RS channel and a low frequency effect (LFE) channel. Alternatively, a different multi-channel audio signal, such as a 7.1 channel audio signal, can be input.

The stereo sound filter unit 500 generates a stereo sound for two-channel headphones by reflecting delay coefficients m₀ through mₙ obtained in a virtual room, gain values g₀ through gₙ, and ITD values and ILD values corresponding to sound pressure differences between sounds incident on the two ears of a listener. For the stereo sound filter unit 500, filter coefficients vary according to the location of virtual speakers and a type and conditions of the virtual room. The stereo sound filter unit 500 includes the LF virtual filter 510, the CF virtual filter 520, the RF virtual filter 530, the LS virtual filter 540, and the RS virtual filter 550, which respectively process stereo sounds of audio signals of the LF channel, the RF channel, the CF channel, the LS channel, and the RS channel. The filters 510 through 550 have identical structures but different delay coefficients.

The signal compensation filter unit 560 compensates for differences in level and time delays between a signal of the LFE channel and signals of the other channels. That is, since the signal of the LFE channel is a signal having a wavelength longer than the width of the head of the listener, the signal of the LFE channel does not pass the stereo sound filter unit 500 and should be matched with the levels and time delays of the signals of the other channels.

The left channel adder 570 adds left channel signals LL, CL, RL, LsL and RsL output from the stereo sound filter unit 500 and a left channel signal output from the signal compensation filter unit 560.

The right channel adder 580 adds right channel signals LR, CR, RR, LsR and RsR output from the stereo sound filter unit 500 and a right channel signal output from the signal compensation filter unit 560.

Finally, left and right channel signals output from the left and right channel adders 570 and 580 pass through an amplifier and are input to the two-channel headphones.

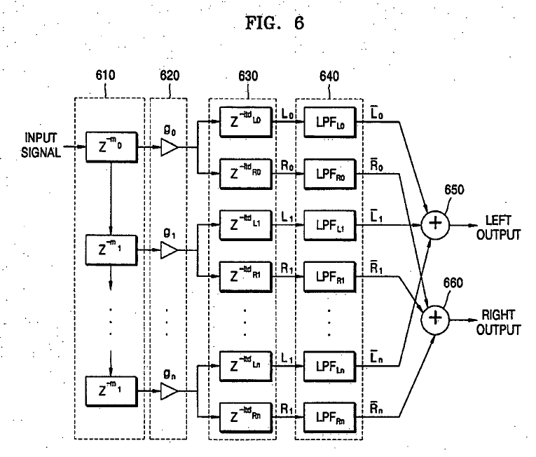

FIG. 6 is a detailed diagram illustrating a virtual filter for a channel of the stereo sound filter unit 500 illustrated in FIG. 5.

Referring to FIG. 6, the virtual filter includes a delay filter unit 610, a multiplier unit 620, an ITD filter unit 630, an ILD filter unit 640, a left channel adder 650, and a right channel adder 660.

The delay filter unit 610 generates a direct sound and reflected sounds by delaying a signal of one of a plurality of channels using a plurality of different delay coefficients m₀ through mₙ previously measured in a virtual room.

The multiplier unit 620 multiplies the sounds delayed by the delay filter unit 610 by predetermined different gain values g₀ through gₙ previously measured in the virtual room.

The ITD filter unit 630 divides the sounds multiplied by the multiplier unit 620 into left and right channel sounds L₀, R₀, . . . , Lₙ, Rₙ by reflecting previously measured time differences between the two ears of the listener on the multiplied sounds.

The ILD filter unit 640 performs low-pass-filtering on the left and right channel sounds divided by the ITD filter unit 630 by reflecting previously measured level differences between the two ears of the listener on the left and right channel sounds.

The left channel adder 650 adds together the left channel sounds passed through the ILD filter unit 640.

The right channel adder 660 adds together the right channel sounds passed through the ILD filter unit 640.

As described above, according to embodiments of the present general inventive concept, by generating a headphone stereo sound using only time delays and low-pass-filtering without using an HRTF, there is almost no distortion in a tone, and an amount of audio processing calculation is reduced. In addition, quality sound as good as reproduced by a home theatre can be received using only two-channel headphones from a DVD or PC without a 5.1 channel speaker system. When the present general inventive concept is applied to a home theatre system, it is possible to listen to a stereo sound reproduced from a 5.1 channel-encoded recording medium using only two-channel headphones regardless of a listener's location. In addition, individual people having differently-shaped heads and/or ears can perceive the same stereo sound even when they receive the sound using their two-channel headphones.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of generating a stereo sound for two-channel headphones from a plurality of channel signals, the method comprising:
generating a direct sound and reflected sounds by delaying one of the plurality of channel signals using a plurality of different delay coefficients corresponding to the direct and reflected sounds;
multiplying the delayed sounds by predetermined different gain values corresponding to the delayed sounds;
dividing the multiplied sounds into left and right channel sounds by reflecting a time difference between two ears of a listener on each of the multiplied sounds;
low-pass-filtering the divided left and right channel sounds by reflecting a level difference between the two ears on each of the left and right channel sounds; and
adding together the low-pass-filtered left channel sounds and the low-pass-filtered sounds of the right channel sounds, respectively.

2. The method of claim 1, wherein the plurality of different delay coefficients vary according to a size of a virtual room.

3. The method of claim 1, wherein the different gain values vary according to an acoustic absorptivity of a virtual room.

4. The method of claim 1, wherein the time difference between the two ears of the listener reflected on each of the left and right channels varies according to angles of incidence of the sounds to the ears.

5. The method of claim 1, wherein the level difference between the two ears reflected on each of the left and right channel sounds varies according to angles of incidence of the sounds to the ears.

6. A headphone stereo sound generating apparatus, comprising:
a stereo sound filter unit to output left and right channel sounds by reflecting a sound pressure difference between two ears of a listener, a delay time in a virtual room, and an intensity of a sound source on each channel signal; and
an adder unit to add together the left channel sounds output from the stereo sound filter unit and the right channel sounds output from the stereo sound filter unit, respectively.

7. The apparatus of claim 6, wherein the stereo sound filter unit provides different output levels and different time delay characteristics according to an input signal and a size of the virtual room.

8. The apparatus of claim 6, further comprising a gain and delay filter unit to compensate for differences in level and time delays between a signal of a low frequency effect channel and signals of other channels.

9. The apparatus of claim 6, wherein the stereo sound filter unit comprises:
a delay filter unit to generate a direct sound and a plurality of reflected sounds by delaying a signal of at least one of a plurality of channels using a plurality of different delay coefficients, corresponding to the direct and reflected sounds, measured in a virtual room;
a multiplier unit to multiply the direct sound and the plurality of reflected sounds generated by the delay filter unit by predetermined different gains, corresponding to the generated sounds, measured in the virtual room;
an ITD filter unit to divide the sounds multiplied by the multiplier unit into the left and right channel sounds by reflecting a time difference between two ears of a listener on each of the multiplied sounds;
an ILD filter unit to low-pass-filter the left and right channel sounds divided by the ITD filter unit by reflecting a level difference between the two ears on each of the left and right channel sounds;
a left channel adder unit to add together the left channel sounds low-pass-filtered by the ILD filter unit; and
a right channel adder unit to add together the right channel sounds low-pass-filtered by the ILD filter unit.

10. The method of claim 1, further comprising:
generating a low-frequency channel signal;
generating a compensation signal to compensate for differences in intensities and delay times between the low-frequency channel signal and signals of the plurality of channels; and
adding the compensation signal to the left and right channel sounds.

11. The method of claim 1, wherein the method does not include using a head-related transfer function.

12. A method of generating stereo sound for two-channel headphones, comprising:
calculating an interaural time difference for each of a direct sound and a plurality of reflected sounds; and
calculating an interaural level difference for each of the direct sound and the plurality of reflected sounds.

13. The method of claim 12, further comprising:
assigning different delay coefficients to each of the direct sound and the reflected sounds corresponding to the interaural time difference of each of the direct sound and the reflected sounds; and
assigning different gain values to each of the direct sound and the reflected sounds corresponding to the interaural level difference of each of the direct sound and the reflected sounds.

14. A stereo sound generating apparatus, comprising:
a generation unit to generate a direct sound and reflected sounds by delaying one of the plurality of channel signals using a plurality of different delay coefficients corresponding to the direct and reflected sounds;
a multiplier unit to multiply the generated sounds by predetermined different gain values corresponding to the generated sounds;
a divider unit to divide the multiplied sounds into left and right channel sounds by reflecting a time difference between two ears of a listener on each of the multiplied sounds;
a filter unit to low-pass-filter the divided left and right channel sounds by reflecting a level difference between the two ears on each of the left and right channel sounds; and
an adder unit to add together the low-pass-filtered left and right channel sounds, respectively.

15. A stereo sound generating apparatus, comprising:
a stereo sound filter unit to delay at least one signal of a plurality of channel signals using a plurality of different time delay coefficients previously-measured in a virtual room, the stereo sound filter unit including a plurality of virtualizer filters; and
a signal compensation filter unit to generate a compensation signal to compensate for differences in intensities and delay times between a signal of a low-frequency channel and the plurality of channel signals.

16. The apparatus of claim 15, wherein the virtualizer filters have substantially-similar structures with different time delay coefficients.

17. The apparatus of claim 15, further comprising a filter unit to low-pass-filter the plurality of channel signals from the stereo sound filter unit.

18. The apparatus of claim 17, further comprising at least one adding unit to add together the plurality of channel signals and the compensation signal.

19. The apparatus of claim 18, further comprising:
at least one amplifier to amplify the added signals from the at least one adding unit and to input the amplified signals into at least one two-channel headphone.

20. The apparatus of claim 15, wherein the stereo sound filter unit comprises a timing unit to calculate an interaural time difference for each of the plurality of channel signals and to assign different ones of the time delay coefficients to the plurality of channel signals based on the interaural time differences.
